(19) United States
(12) Patent Application Publication
(10) Pub. No.: US 2002/0117773 A1
(43) Pub. Date: Aug. 29, 2002

(54) Molding die, hollow ceramic monolithic support and method of manufacturing the same, and catalytic converter system

(76) Inventors: Keiichi Yamada, Toyoake-city (JP); Yuichi Hiratsuka, Kariya-city (JP); Masakazu Murata, Shinshiro-city (JP); Masakazu Tanaka, Okazaki-city (JP)

Correspondence Address: Nixon & Vanderhye, P.C., 8th Floor, 1100 North Glebe Road, Arlington, VA, 22201-4714, US

(21) Appl. No.: 10/080,413

(22) Filed: Feb. 25, 2002

(30) Foreign Application Priority Data
Feb. 26, 2001 (JP) 2001-50844
Feb. 26, 2001 (JP) 2001-50845
Dec. 10, 2001 (JP) 2001-376245

(51) Int. Cl. B29C 47/20

(52) U.S. Cl. 264/209.1; 264/211.11; 425/380; 425/467

(57) ABSTRACT

The present invention provides a hollow ceramic monolithic support that has high isostatic strength, a method of manufacturing the hollow ceramic monolithic support at low cost, and a molding die therefor.

According to the present invention, the hollow ceramic monolithic support comprises a main body 82 that has a multitude of cells 45 surrounded by ribs 84 of a honeycomb structure, the hollow space 80 made at the center of the main body 82 so as to penetrate therethrough in the longitudinal direction, the outer periphery skin portion 81 that covers the outer peripheral surface of the main body 82 and the inner periphery skin portion 83 that covers the inner peripheral surface of the main body 82. Ribs 84 located in a layer in a range from one to 10 cells from the inner periphery skin portion 83 are made to form high strength portions S2 that have higher strengths than the other portion P of the ribs located outside thereof.

### BACKGROUND OF THE INVENTION

1. Field of the Invention

The present invention relates to a honeycomb structure that is made of cordierite and is used as a catalyst support for a exhaust gas purifying system of an internal combustion engine, and a method of manufacturing the same.

2. Description of the Related Art

As exhaust gas purifying system of automobile internal combustion engines, there is a catalytic converter system that comprises a ceramic support whereon a noble metal such as platinum or rhodium is supported as the catalyst. The catalytic converter system converts toxic components of the exhaust gas such as HC, CO and NOx into non-toxic substances such as H₂O and CO₂, by making use of the oxidizing reaction or the oxidizing/reducing reaction using the noble metal as the catalyst.

The catalyst support used in the catalytic converter system uses, as the substrate, a so-called monolithic support made in the form of honeycomb consisting of ribs and cells surrounded thereby, while the noble metal catalyst is supported on the ribs of the monolithic support.

The catalyst described above must be heated to a certain temperature in order to be active and efficiently purify the exhaust gas. In other words, there has been a problem that the inner temperature of the converter is low and the exhaust gas cannot be sufficiently purified immediately after the internal combustion engine has started. Therefore, it has become a common practice, recently, to install two catalytic converters in series in such regions where strict emission control regulations are imposed.

Specifically, a catalytic converter installed immediately downstream of the engine (hereafter referred to as CC catalyst) and a catalytic converter installed further away from the engine (hereafter referred to as UF catalyst) are connected in series. The CC catalyst has the function to improve the activity when the exhaust gas temperature is low (low-temperature activity) and the UF catalyst has the function to improve the final purification performance. The activity of the CC catalyst can be improved through means that quickly heat the catalyst by installing the catalyst as near as possible to the engine or decreasing the rib thickness of the monolithic support, or means for improving the catalyst performance at low temperatures by employing a noble metal that has a good low-temperature activity or using the noble metal in the form of smaller particles. It is especially effective, to improve the low-temperature activity, to use smaller noble metal particles.

However, decreasing the particle size of the noble metal gives rise to the problem of heat resistance. That is, when the temperature rises (for example, to 800° C. or higher), the catalyst particles coagulate due to the heat, resulting in a great decrease in the specific surface area and, consequently, a decrease in the low-temperature activity. To avoid this problem, the so-called bypass CC catalyst system has been proposed in which the exhaust gas is introduced into the CC catalyst immediately after starting the engine and during a medium load operation when the exhaust gas temperature is not so high, while the exhaust gas is not introduced into the CC catalyst during high-load operation when the exhaust gas temperature is high.

As one means for bypassing the exhaust gas, there is such a system that provides a hole in the central portion of a monolithic support and a butterfly valve, installed in the central portion of the hollow monolithic support, to switch the exhaust gas path between the monolithic portion and the central portion. In this system, all the exhaust gas is introduced into the support thereby to achieve high low-temperature activity by closing the butterfly valve immediately after starting the engine, and the valve is opened to pass the exhaust gas through the central portion in order to prevent thermal coagulation of the CC catalyst during a high load operation.

The hollow monolithic support used in the system described above is usually made by boring a hole at the center of the monolithic support by means of a drill cutter as disclosed, for example, in Japanese Unexamined Patent Publication No. 9-220480. When boring a hole in a honeycomb structure that has been extruded in the form of cylinder, however, adding the boring process increases the number of manufacturing processes. Also the portion of the honeycomb removed by boring is wasted. As a result, the catalyst support cannot be manufactured at a low cost by this method.

Boring also produces a structural defect in the monolithic support, that decreases the strength of the support, particularly the isostatic strength (static breakage strength). Above all, in the inner surface of the bore made in the honeycomb structure, the cell walls (ribs) of the honeycomb structure as thin as 0.05 to 0.3 mm are exposed. As the cell walls are mated directly with a pipe via a mat, there is a problem that cell walls are destroyed during assembling and when the mat expands at a high temperature, such as the rapid thermal expansion of INTERLUM MAT at a temperature of 400° C. or higher.

Even when the honeycomb structure is reinforced with a ceramic material of the same type so as to prevent the trouble described above from occurring, the layer on the inner surface of the hole bored in the honeycomb structure has uneven thickness leading to a markedly reduced strength compared to the original honeycomb structure. A metallic support that has high strength, on the other hand, is made by forming a roll of flat metal foil and corrugated foil placed one on another, and therefore is expensive to manufacture because of the high coefficient of thermal expansion and the difficulty in rolling, processing and bonding the foil. Thus it is difficult to use a metallic foil for the catalyst support.

### SUMMARY OF THE INVENTION

The present invention has been made to solve the problems described above. An object of the present invention is to provide a hollow ceramic monolithic support that has high isostatic strength, a method of manufacturing the hollow ceramic monolithic support with a low manufacturing cost and a molding die used therein, and further to provide a catalytic converter system that employs the hollow ceramic monolithic support.

According to a first aspect of the invention, a molding die for molding a hollow ceramic monolithic support is provided that comprises a die having an introduction hole section provided with introduction holes through which a material is introduced and a slit section provided with slits that communicate with the introduction holes for forming the material into honeycomb shape; an outer periphery guide ring that has an outer periphery erected portion extending from the peripheral end of the slit section along the extruding direction and an outer periphery protruding portion that protrudes from the outer periphery erected portion inwardly and is separated from the slit section by a gap provided therebetween, and an inner periphery guide ring that has an inner periphery erected portion extending from the center of the slit section along the extruding direction and an inner periphery protruding portion protruding from the inner periphery erected portion outwardly while being separated from the slit section by a gap provided therebetween.

The molding die of the present invention has the inner periphery guide ring in addition to the outer periphery guide ring. The outer periphery guide ring and the inner periphery guide ring each has the outer periphery erected portion, the outer periphery protruding portion, the inner periphery erected portion and the outer periphery erected portion, and is separated from the slit section by the gap provided therebetween. As a result, the method of manufacturing the hollow ceramic monolithic support can be reliably implemented, as described below, when the molding die is used in the extrusion molding process. Thus it is made possible to easily obtain the hollow ceramic monolithic support comprising an outer periphery skin portion, an inner periphery skin portion and a main body of honeycomb structure interposed therebetween, that are molded integrally. This allows manufacture of a hollow ceramic monolithic support that has high isostatic strength with a low manufacturing cost.

According to a second aspect of the invention, a method of manufacturing the hollow ceramic monolithic support is provided in which a ceramic material is molded by extrusion using a molding die comprising a die that has an introduction hole section provided with introduction holes through which the material is introduced and a slit section having slits that communicate with the introduction holes for forming the material into honeycomb shape, an outer periphery guide ring that has an outer periphery erected portion extending from the outer peripheral end of the slit section along the extruding direction and an outer periphery protruding portion protruding from the outer periphery erected portion inwardly while being separated from the slit section by a gap provided therebetween, and an inner periphery guide ring that has an inner periphery erected portion extending from the center of the slit section along the extruding direction and an inner periphery protruding portion protruding from the inner periphery erected portion outwardly while being separated from the slit section by a gap provided therebetween, wherein the outer periphery skin portion is formed from the ceramic material that has passed through the gap between the outer periphery protruding portion and the slit section of the outer periphery guide ring, the inner periphery skin portion is formed from the ceramic material that has passed through the gap between the inner periphery protruding portion and the slit section of the inner periphery guide ring, and the main body of honeycomb structure surrounded by the inner periphery skin portion and the outer periphery skin portion is formed from the ceramic material that has been extruded through the slit section, thereby to make a hollow ceramic monolithic support that has a hollow space in the inner periphery skin portion.

According to this method of manufacturing, extrusion molding is carried out by using the molding die of the particular constitution described above. That is, the molding die that has the outer periphery guide ring and the inner periphery guide ring is used as described above. This makes it possible to easily mold the hollow ceramic monolithic support that has the outer periphery skin portion and the inner periphery skin portion on the outer peripheral surface and the inner peripheral surface of the main body of honeycomb structure, respectively, simply by the extrusion molding process described above.

The gap between the inner periphery protruding portion and the slit section is preferably in a range from 0.05 to 2 mm. When the gas is less than 0.05 mm, the inner periphery skin portion may not be formed stably and, when the gap is larger than 2 mm, excessive material is supplied thereby leading to such troubles as the formation of deformed cells in the main body of honeycomb structure and undulating skins, resulting in decreased strength. For these reasons, the gap is preferably in a range from 0.1 to 0.5 mm.

With the gap between the outer periphery protruding portion and the slit portion denoted as C1 and the gap between the inner periphery protruding portion and the slit section denoted as C2, the ratio C1/C2 is preferably from 0.8 to 1.2. When the ratio C1/C2 is set in a range from 0.8 to 1.2, the difference in thickness between the inner periphery skin portion and the outer periphery skin portion can be controlled to within a certain level in the hollow ceramic monolithic support manufactured by the manufacturing method of the present invention or by using the molding die.

When the ratio C1/C2 is less than 0.8, the outer periphery skin portion becomes too thin compared to the inner periphery skin portion. Consequently, the hollow ceramic monolithic support that has been molded by extrusion experiences uneven shrinkage in the axial direction when being dried. Such an uneven shrinkage may cause deformation of the outer periphery skin portion or another trouble. When the ratio C1/C2 is larger than 1.2, on the other hand, the inner periphery skin portion becomes too thin compared to the outer periphery skin portion. Consequently, the hollow ceramic monolithic support may experience deformation of the inner periphery skin portion or another trouble during drying.

In the die described above, the slits located in a portion of size in a range from one to 10 cells from the distal end of the inner periphery protruding portion are preferably wider than the other slits. The hollow ceramic monolithic support that has been molded by extrusion with the molding die described above has high strength at the inner periphery protruding portion. Thus, the hollow ceramic monolithic support that has been molded by extrusion is less likely to experience trouble at the inner periphery protruding portion even when it is soft before being dried. Thus, the process of manufacturing the hollow ceramic monolithic support using the molding die described above is an efficient process with a high production yield.

In the die described above, the slits located in a portion in a range from one to 10 cells from the distal end of the outer periphery protruding portion are preferably wider than the other slits. The hollow ceramic monolithic support that has been molded by extrusion with the molding die described above has high strength not only after completion but also during the manufacturing process. Thus the hollow ceramic monolithic support that has been molded by extrusion with the molding die described above is less likely to experience trouble even with the molding die described above. Thus the process of manufacturing the hollow ceramic monolithic support is an efficient process with a high production yield.

According to a third aspect of the invention, a hollow ceramic monolithic support is provided that comprises a main body having a multitude of cells surrounded by ribs in honeycomb structure, a hollow space formed to penetrate through the central portion of the main body in the longitudinal direction, an outer periphery skin portion that covers the outer peripheral surface of the main body and an inner periphery skin section that covers the inner peripheral surface of the main body, wherein the ribs located in a portion in a range from one to 10 cells from the inner periphery skin section are made stronger than the ribs located in the outer portion.

The hollow ceramic monolithic support of the has a cylindrical shape having a hollow space in the central portion of the main body, as described above, with the outer periphery skin portion provided on the outer peripheral surface and the inner periphery skin portion provided on the inner peripheral surface. As a result, the ribs are not exposed to the outside on the outer and inner peripheral surfaces of the main body, and the ribs are tied to each other by the outer periphery skin portion and the inner periphery skin portion. Thus the rupture strength is improved by the existence of the outer periphery skin portion and the inner periphery skin portion so as to endure even when loaded on the outer peripheral surface or on the inner peripheral surface.

In addition, the ribs located in a portion in a range from one to 10 cells in contact with the inner periphery skin portion are made stronger than the ribs located in the outer portion. Thus rupture strength is improved further so as to endure when loaded on the inner peripheral surface. According to the present invention, therefore, the rupture strength to endure the stress caused by a load applied on the inner peripheral surface can be improved drastically by providing the inner periphery skin portion and increasing the strength of the ribs that are in contact with the inner periphery skin portion.

The high strength portion becomes less effective in improving the strength, when the size of the high strength portion is less than one cell from the inner periphery skin portion. When the size of the high strength portion exceeds the region of 10 cells from the inner periphery skin portion, the effect of improving the strength is saturated and it is not of much use to provide larger high strength portion.

Thus, according to the present invention, a hollow ceramic monolithic support having high isostatic strength, despite the hollow configuration, can be provided.

The ribs located in a portion in a range from one to 10 cells on the side of the outer periphery skin portion is preferably made stronger than the ribs in the other portion located inside. Thus rupture strength can be greatly improved so as to endure when loaded on the outer peripheral surface by increasing the strength of the ribs that are in contact with the outer periphery skin portion.

In this case, too, the high strength portion becomes less effective, in improving the strength, when the size of the high strength portion is less than one cell from the outer periphery skin portion. When the size of the high strength portion exceeds the region of 10 cells from the outer periphery skin portion, the effect of improving the strength is saturated and it is not of much use to provide a larger high strength portion.

The high strength portion of the ribs is preferably made thicker so as to make the strength higher than that of other portions. In this case, the high strength portion can be formed by increasing the thickness thereof so as to increase the strength of the ribs surely and easily.

The high strength portion of the ribs can be formed also by decreasing the void ratio of the ribs.

Assuming the thickness of the outer periphery skin portion as T1 and the thickness of the inner periphery skin portion as T2, the ratio T1/T2 is preferably in a range from 0.8 to 1.2. By setting the ratio T1/T2 of the thickness T1 of the outer periphery skin portion to the thickness T2 of the inner periphery skin portion in the range from 0.8 to 1.2, the shrinkage ratio in the axial direction can be made uniform when drying the material molded by extrusion.

When the ratio T1/T2 is less than 0.8, the outer periphery skin portion becomes too thin compared to the inner periphery skin portion. Consequently, the hollow ceramic monolithic support experiences uneven shrinkage in the axial direction when drying, thus causing deformation of the outer periphery skin portion or another trouble. When the ratio T1/T2 is larger than 1.2, on the other hand, the inner periphery skin portion becomes too thin, and the hollow ceramic monolithic support may experience deformation of the inner periphery skin portion or another trouble during drying.

In the hollow ceramic monolithic support described above, ratio of area occupied by the hollow space in the end face is preferably in a range from 6.25% to 56.25%. When the ratio is less than 6.25%, pressure loss in the hollow space may increase. When the ratio is higher than 56.25%, exhaust gas purifying performance of the hollow ceramic monolithic support may become insufficient.

According to a fourth aspect of the present invention, a catalytic converter system, installed in the exhaust system of an internal combustion engine, is provided that comprises a first catalytic converter constituted from the catalytic converter system described in one of claims 11 through 14 and a second catalytic converter constituted from a solid ceramic monolithic support that has a multitude of cells surrounded by ribs in honeycomb structure and an outer periphery skin portion that covers the outer peripheral surface thereof, wherein the first catalytic converter is disposed upstream in the exhaust system, incorporates the hollow ceramic monolithic support having a first catalyst supported thereon and has a bypass passageway disposed in the hollow space, a purifying path consisting of the multitude of cells disposed to surround the bypass passageway and passageway switching means that switches the passageway for the exhaust gas between the bypass passageway and the purifying path, and the second catalytic converter incorporates the solid ceramic monolithic support having a second catalyst supported thereon, while the first catalyst begins to be activated at a lower temperature than the second catalyst does.

The catalytic converter system has at least the two converters as described above, and the converters incorporate monolithic supports of different structures and catalysts of different types supported thereon. Thus both durability and purifying performance can be improved by selectively using the first catalytic converter and the second catalytic converter. Specifically, the catalytic converter system selects the bypass passageway or the purifying path of the first catalytic converter to pass the exhaust gas, in accordance with the temperature of the exhaust gas flowing through the exhaust system or the temperature of the hollow ceramic monolithic support.

When the temperature of the exhaust gas is low, for example, the exhaust gas is directed through the purifying path. This makes it possible to efficiently purify the exhaust gas at a low temperature by taking advantage of the characteristics of the first catalyst that has an activation initiating temperature lower than that of the second catalyst supported on the hollow ceramic monolithic support. When the temperature of the exhaust gas is high, the passageway of the exhaust gas is switched by the passageway switching means so as to pass the exhaust gas through the bypass passageway. This results in stable purification of the exhaust gas at a high temperature by taking advantage of the higher activation initiating temperature and better durability of the second catalyst compared to the first catalyst.

Also, it is made possible to prevent the problem, of the first catalyst coagulating due to heat, that leads to decreased purification performance, caused by overheating of the hollow ceramic monolithic support when the exhaust gas of a high temperature is introduced into the purification path.

Thus the catalytic converter system of the present invention can demonstrate the effect of efficiently purifying the exhaust gas over a wide range of temperatures for an extended period of time.

The hollow ceramic monolithic support used in the first catalytic converter has, in addition to the inner periphery skin portion, the high strength portion provided around the inner periphery skin portion, as described above. This constitution makes the hollow ceramic monolithic support durable against breakage when loaded on the inner peripheral surface including thermal shock and vibration, and when operated under harsh conditions.

The passageway switching means is preferably constituted so as to switch between the bypass passageway or the purifying path depending on the load on the internal combustion engine. The load on the internal combustion engine has high correlation with the temperature of the exhaust gas or the temperature of the hollow ceramic monolithic support. The load on the internal combustion engine can be estimated from the vehicle information such as the degree of throttle opening and the amount of air intake.

Therefore, when the catalytic converter system that switches the path of flowing the exhaust gas in accordance to the load on the internal combustion engine is used, such an effect can be achieved with a relatively simple system constitution that efficiently purifies the exhaust gas over a wide range of temperatures for an extended period of time as described above.

The passageway switching means is preferably constituted so as to switch between the bypass passageway and the purifying path depending on the cooling medium temperature of the internal combustion engine. The cooling medium is water if the engine is cooled with water, or air if the engine is cooled with air. Temperature of the water or air after cooling the internal combustion engine has high correlation with the temperature of the exhaust gas or the temperature of the hollow ceramic monolithic support. The cooling medium temperature can be measured with a simple and inexpensive sensor that has a small operating temperature range.

Therefore, when the cooling medium temperature is monitored, such an effect can be achieved with a relatively simple system constitution that efficiently purifies the exhaust gas over a wide range of temperatures for an extended period of time.

The cooling medium temperature may be estimated by monitoring the temperature of a component of the internal combustion engine or an associated equipment that makes contact with the cooling medium. For example, temperature of a radiator fin or air-cooled engine fin may be used in lieu of the cooling medium temperature.

The passageway switching means is preferably constituted so as to switch between the bypass passageway and the purifying path in accordance to the combination of the load on the internal combustion engine and the cooling medium temperature. The exhaust gas temperature can be estimated more precisely by making use of the combination of the load on the internal combustion engine and the cooling medium temperature. Thus the effect of efficiently purifying the exhaust gas over a wide range of temperatures can be more fully utilized while maintaining the durability of the low-temperature active catalyst.

The first catalyst is preferably a very low temperature activating catalyst that has activation initiating temperature at 300° C. or lower, more preferably 200° C. or lower. When the activation initiating temperature of the catalyst supported by the hollow ceramic monolithic support is higher than 300° C., the exhaust gas may not be sufficiently purified immediately after starting the internal combustion engine. When the activation initiating temperature of the catalyst is 200° C. or lower, the exhaust gas immediately after starting the internal combustion engine can be fully purified.

### BRIEF DESCRIPTION OF THE DRAWINGS

FIG. 1(a) is a plan view and FIG. 1(b) is a sectional view taken along lines IB-IB of FIG. 1(a) of a molding die according to the first embodiment.

FIG. 2(a) is a plan view, FIG. 2(b) is a side view and FIG. 2(c) is a sectional view taken along lines IIC-IIC of a die according to the first embodiment.

FIG. 3(a) is a plan view and FIG. 3(b) is a sectional view taken along lines IIIB-IIIB of FIG. 3(a) of an outer periphery guide ring according to the first embodiment.

FIG. 4(a) is a plan view and FIG. 4(b) is a sectional view taken along lines IVB-IVB of FIG. 4(a) of an inner periphery guide ring according to the first embodiment.

FIG. 5 shows the state of extrusion molding using the molding die according to the first embodiment.

FIG. 6 is a perspective view of a hollow ceramic monolithic support according to the first embodiment.

FIG. 7 is a perspective view of a hollow ceramic monolithic support according to the second embodiment.

FIG. 8(a) shows an inner periphery portion and FIG. 8(b) shows an outer periphery portion of the ribs according to the second embodiment in enlarged views.

FIG. 9(a) is a plan view and FIG. 9(b) is a sectional view taken along lines IXB-IXB of FIG. 9(a) of a molding die according to the second embodiment.

FIG. 10(a) is a plan view, FIG. 10(b) is a side view and FIG. 10(c) is a sectional view taken along lines XC-XC of FIG. 10(b) of a die according to the second embodiment.

FIG. 11 shows the constitution of a catalytic converter system according to the third embodiment.

FIGS. 12(a) through 12(c) show a process of manufacturing a hollow ceramic monolithic support according to the seventh embodiment.

FIG. 13 is a sectional view showing an outer periphery protruding portion and an inner periphery protruding portion of another example of die according to the first embodiment.

FIG. 14 is a perspective view of another example of the hollow ceramic monolithic support having a substantially rectangular cross section according to the first embodiment.

FIG. 15 is a perspective view of another example of the hollow ceramic monolithic support having a substantially oval cross section according to the first embodiment.

FIG. 16 is a flow chart showing the control of a catalytic converter system according to the fourth embodiment.

FIG. 17 is a flow chart showing the control of a catalytic converter system according to the fifth embodiment.

### DETAILED DESCRIPTION OF THE PREFERRED EMBODIMENTS

First Embodiment

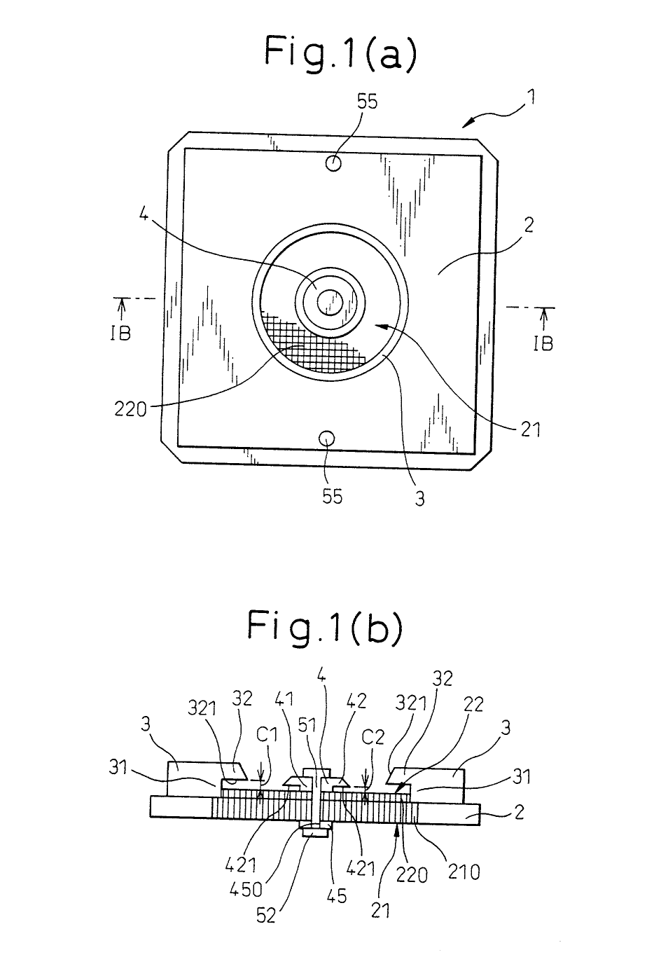

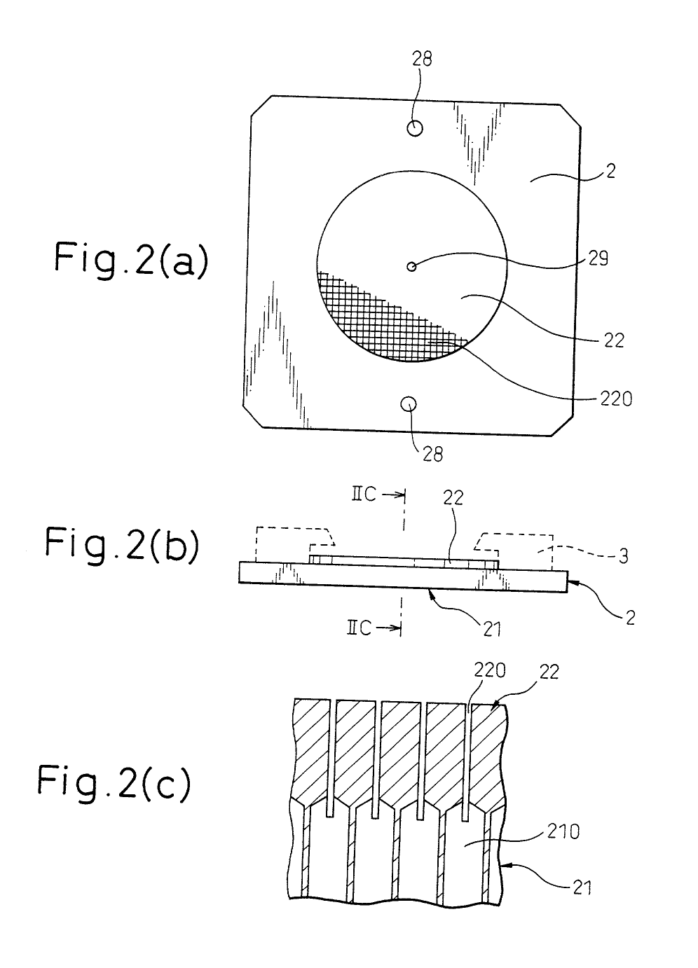

A method of manufacturing the hollow ceramic monolithic support and a molding die according to the first embodiment of the present invention will be described below with reference to FIGS. 1(a) through 6.

The molding die 1 used in this embodiment has a die 2, an outer periphery guide ring 3 and an inner periphery guide ring 4 as shown in FIGS. 1(a) and 1(b).

The molding die 2 has an introduction hole section 21 provided with introduction holes 210 through which a material is introduced, and a slit section 22 provided with slits 220 that communicate with the introduction holes 210 for forming the material into honeycomb shape. The slit section 22 protrudes from the surrounding thereof and has slits 220 formed in rectangular grid configuration. Provided on the opposite side of the slit section 22 is the introduction hole section 21 having a multitude of the introduction holes 210 formed so as to communicate with the crossing portions of the slits 220.

Provided at the center of the die 2 is a through hole 29 through which a bolt 51 is inserted for fastening an inner periphery guide ring 4 to be described later. Pin holes 28 are provided at two positions outside the slit section 22 for fastening an outer periphery guide ring 3 to be described later.

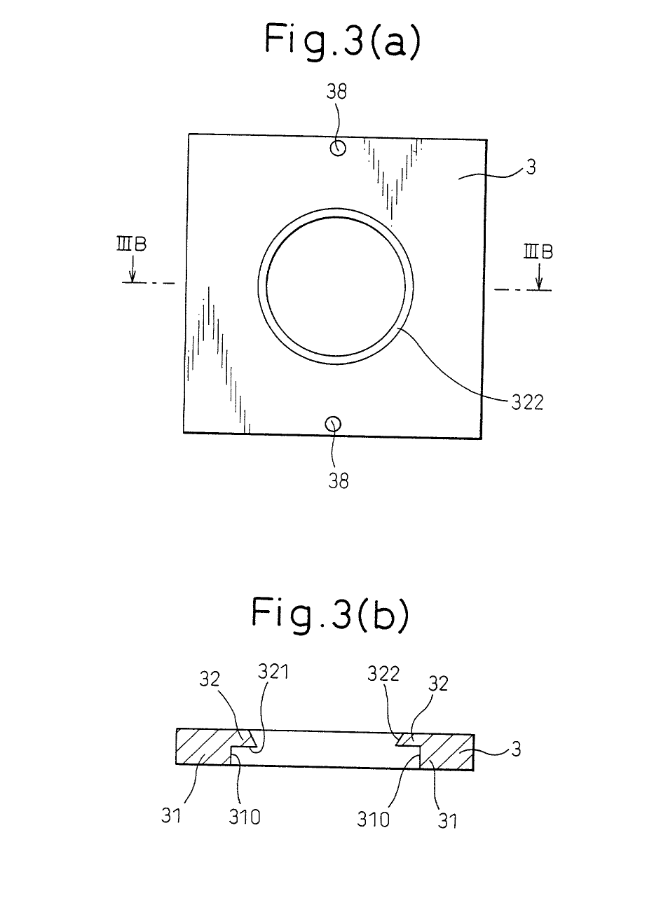

The outer periphery guide ring 3 has an outer periphery erected portion 31 formed to extend from the outer peripheral end of the slit section in the direction of extrusion, and an outer periphery protruding portion 32 that protrudes from the outer periphery erected portion 31 inward and is separated from the slit section 22 by a gap C1 (FIG. 1(b)), as shown in FIGS. 3(a) and 3(b).

The outer periphery erected portion 31 has a ring shape, with an inner peripheral surface 310 thereof being formed so as to abut the outer peripheral surface of the slit section 22 of the die 2. The gap C1 is secured by making the height of the outer periphery erected portion 31 greater than the height of the slit section 22. The gap C1 is set to 0.2 mm in this example.

The outer periphery protruding portion 32 is formed so that an outer periphery opposing surface 321 that opposes the slit section 22 protrudes inwardly so as to secure the gap C1 from the slit section 22 as shown in FIGS. 1(a), 1(b), 3(a) and 3(b). The outer periphery protruding portion 32 has a tapered surface 322 formed on the inside thereof so as to expand gradually along the extruding direction. Distal end of the outer periphery protruding portion 32 is formed in circular shape of a size that matches the outer dimension of the hollow ceramic monolithic support 8 to be manufactured.

The outer periphery guide ring 32 has a pin hole 38 for fastening the outer periphery guide ring onto the die 2.

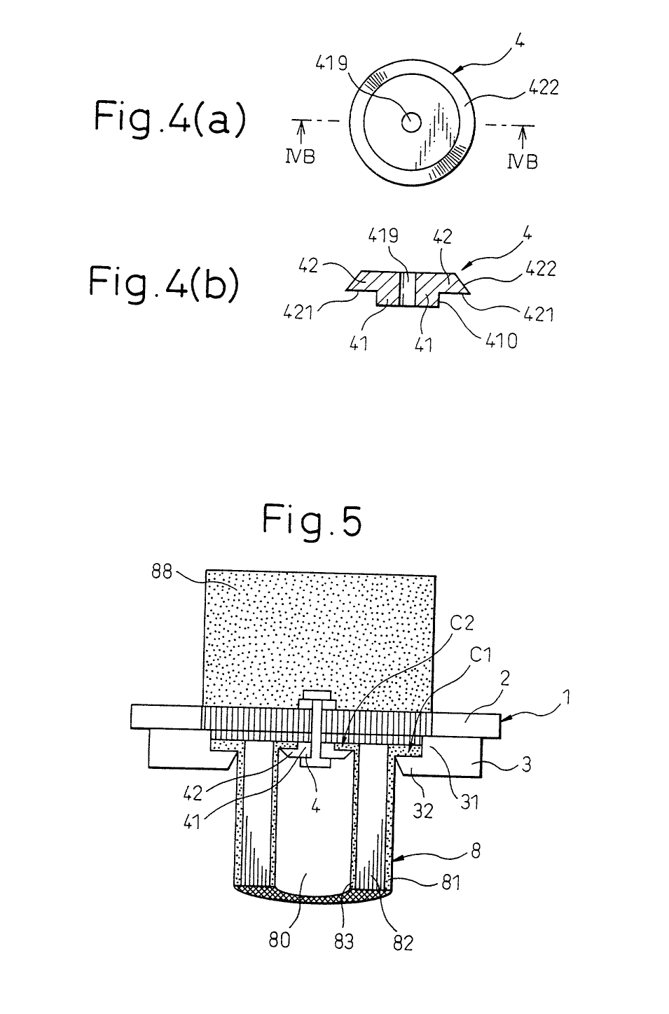

The inner periphery guide ring 4 has an inner periphery erected portion 41 formed to extend from the center of the slit section 22 in the direction of extrusion, and an inner periphery protruding portion 42 that protrudes from the inner periphery erected portion 41 outward and is separated from the slit section 22 by a gap C2 (FIG. 1(b)), as shown in FIGS. 4(a) and 4(b).

The inner periphery erected portion 41 has a cylindrical shape having a through hole 419 at the center thereof and an outer peripheral surface 410. The gap C2 is secured by means of the height of the inner periphery erected portion 41. The gap C2 is set to 0.2 mm in this example.

The inner periphery protruding portion 42 is formed so that an inner periphery opposing surface 421 that opposes the slit section 22 protrudes outwardly so as to secure the gap C2 from the slit section 22 as shown in FIGS. 1(a), 1(b), 4(a) and 4(b). The inner periphery protruding portion 42 has a tapered surface 422 formed on the outside thereof so as to contract gradually along the extruding direction. The distal end of the inner periphery protruding portion 42 is formed in circular shape of a size that matches the inner dimension of the hollow ceramic monolithic support 8 to be manufactured.

The molding die 1 of this example is made by assembling the outer periphery guide ring 3 and the inner periphery guide ring 4 on the die 2.

When assembling the outer periphery guide ring on the die 2, the outer periphery guide ring 3 is placed on the outer periphery of the slit section 22 of the die 2, and the pins 55 are inserted into the pin holes 28, 38 for securing.

When fastening the inner periphery guide ring 4 onto the die 2, a disk-shaped adjustment plate 45 that has a through hole 450 is prepared, and the adjustment plate 45, the die 2 and the inner periphery guide ring 4 are assembled so that the through holes 450, 29 and 419 are aligned concentrically. The bolt 51 is passed through the through holes 450, 29 and 419 and is secured with a nut 52. Thus the inner periphery guide ring 4 is secured onto the die 2.

Now a method of manufacturing the hollow ceramic monolithic support 8 using the molding die 1 having the constitution described above will be described below.

First, the molding die 1 is set at the distal end of a screw extrusion molding apparatus that is not shown in the drawing. A kneaded green ceramic material is charged into the screw extrusion molding apparatus to carry out extrusion molding.

In this example, a powdery material prepared in such a proportion that constitutes cordierite as the final product with a binder and other components added thereto was used as the ceramic material.

The ceramic material that is extruded continuously by the screw extrusion molding apparatus passes through the molding die 1 thereby to be molded into the hollow ceramic monolithic support 8.

As shown in FIG. 5, an outer periphery skin portion 81 is formed from the ceramic material 88 that passes through the gap C1 provided between the outer periphery protruding portion 32 and the slit section 22 of the outer periphery guide ring 3. The ceramic material 88 that is extruded to pass through the slit section 22 that opposes the outer periphery opposing surface 321 of the outer periphery protruding portion 32 flows into the gap C1 surrounded by the slit section 22, the outer periphery opposing surface 321 and the inner surface 310 of the outer periphery guide ring 3, so as to flow toward the center, and changes direction at the end of the outer periphery protruding portion 32 so as to flow in the direction of extrusion thereby to form the outer periphery skin portion 81.

Also, as shown in the drawing, an inner periphery skin portion 83 is formed from the ceramic material 88 that passes between the inner periphery protruding portion 42 and the slit section 22 of the inner periphery guide ring 4. The ceramic material 88 that is extruded to pass through the slit section 22 that opposes the inner periphery opposing surface 421 of the inner periphery protruding portion 42 flows into the gap C2 surrounded by the slit section 22, the inner periphery opposing surface 421 and the inner surface 410 of the inner periphery guide ring 4, so as to flow toward the outer periphery, and changes direction at the end of the inner periphery protruding portion 42 to flow in the direction of extrusion thereby to form the inner periphery skin portion 83.

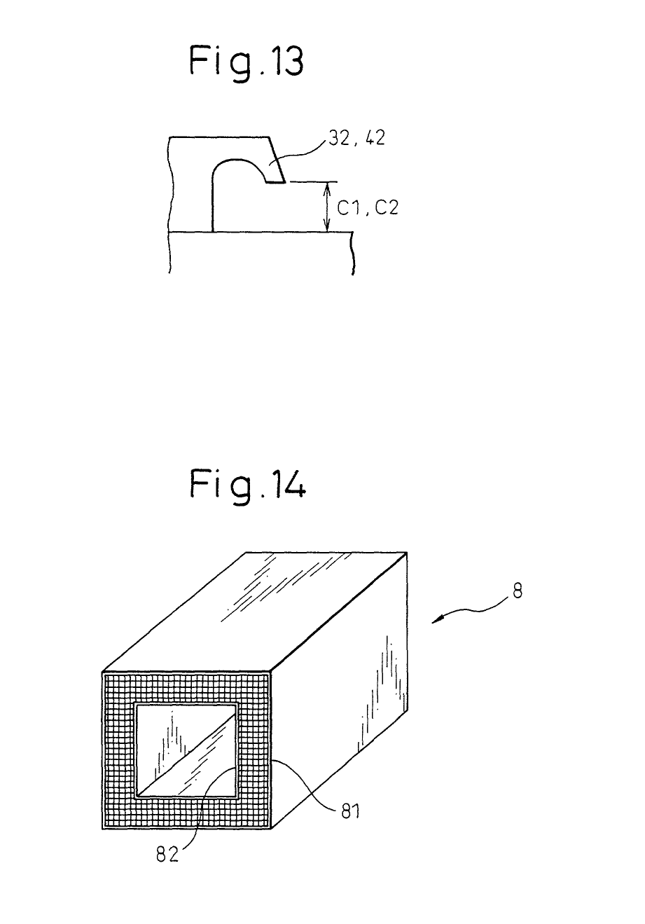

It is also effective to form the outer periphery protruding portion 32 and the inner periphery protruding portion 42 to have cross sections at the distal end thereof as shown in FIG. 13. In this case, the ceramic material 88, that has been introduced into the gap C1 surrounded by the outer periphery opposing surface 321 and the inner surface 310 or into the gap C2 surrounded by the inner periphery opposing surface 421 and the inner surface 410, can flow smoothly along a path of an arc shape toward the distal end of the outer periphery protruding portion 32 or the inner periphery protruding portion 42.

As shown in the drawing, the ceramic material 88 that is extruded through the slit section 22 surrounded by the inner periphery skin portion 83 and the outer periphery skin portion 81 is formed into the main body 82 of honeycomb shape having the rectangular grid.

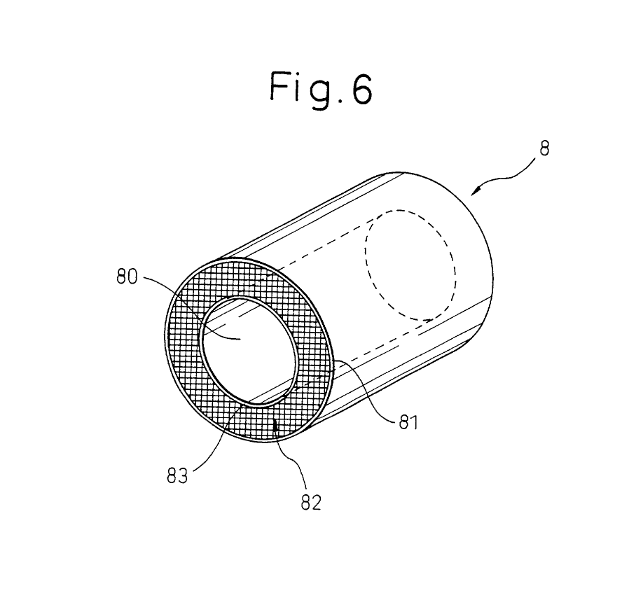

As the outer periphery skin portion 81, the main body 82 and the inner periphery skin portion 83 are formed integrally and at the same time, the hollow ceramic monolithic support 8 (FIG. 6) that has a hollow space 80 formed in the inner periphery skin portion 83 can be manufactured continuously.

The hollow ceramic monolithic support 8 thus manufactured has the hollow space 80 and the inner periphery opposing surface 83 that surrounds the hollow space 80 is formed integrally on the inner surface of the main body 82. As a result, the hollow ceramic monolithic support 8 has a very high isostatic strength.

Since the hollow ceramic monolithic support 8 of the constitution described above can be manufactured simply by extrusion molding as described above, waste of material and the need for the additional processes of the prior art are eliminated, thus reducing the manufacturing cost.

While the main body 82 of rectangular honeycomb is described in the example described above, the shape may be changed to a hexagon or another shape.

The slit section 22, the outer periphery guide ring 3 and the inner periphery guide ring 4 are assumed to have circular shapes in the example described above, they may also be made in an oval, a race track or another shape.

Dimensions of the adjustment plate 45, the outer periphery guide ring 3 and the inner periphery guide ring 4, dimension of the slit 220 of the slit section 22, and the dimension and location of the introduction holes of the introduction hole section 21 may also be altered so as to match the dimension and shape of the hollow ceramic monolithic support 8 to be manufactured.

The means for fastening the die 2, the outer periphery guide ring 3 and the inner periphery guide ring 4 together may also be changed to other binding means such as the use of other fixtures, brazing or thermal diffusion.

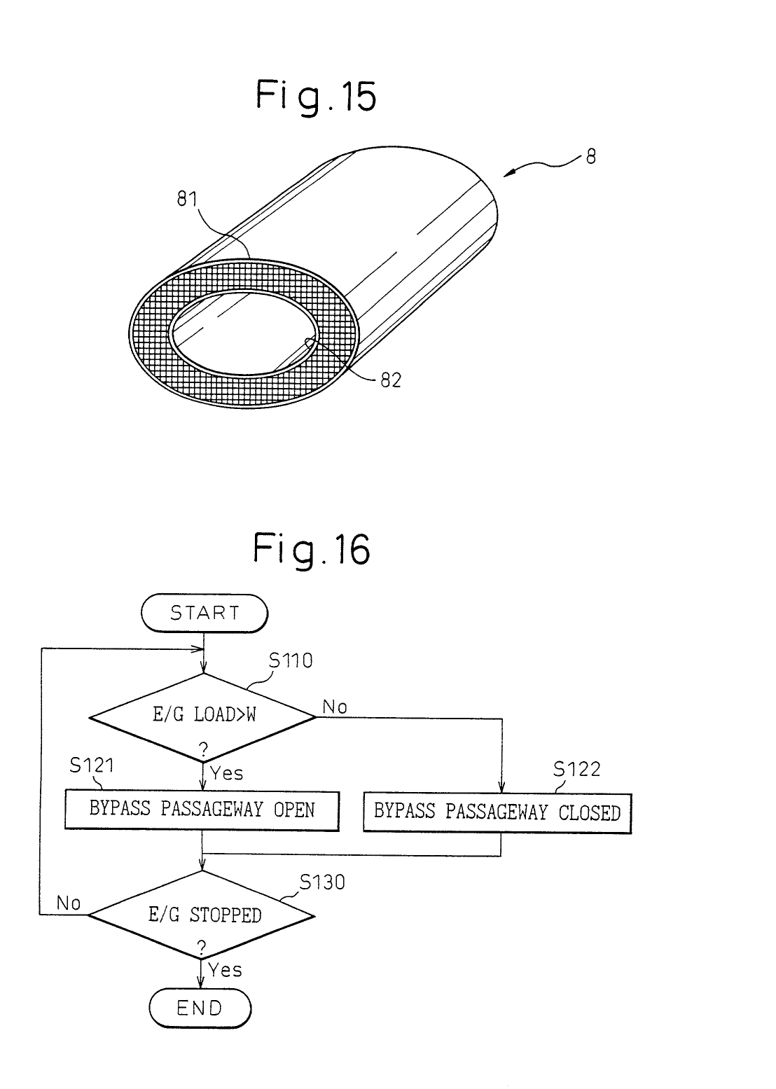

Moreover, shape of the hollow ceramic monolithic support 8 is not limited to the substantially circular cross section as described above, and may be substantially rectangular section as shown in FIG. 14 or substantially oval section as shown in FIG. 15. The shape of the hollow ceramic monolithic support 8 should be determined in consideration of the installing position and available space for installation.

Second Embodiment

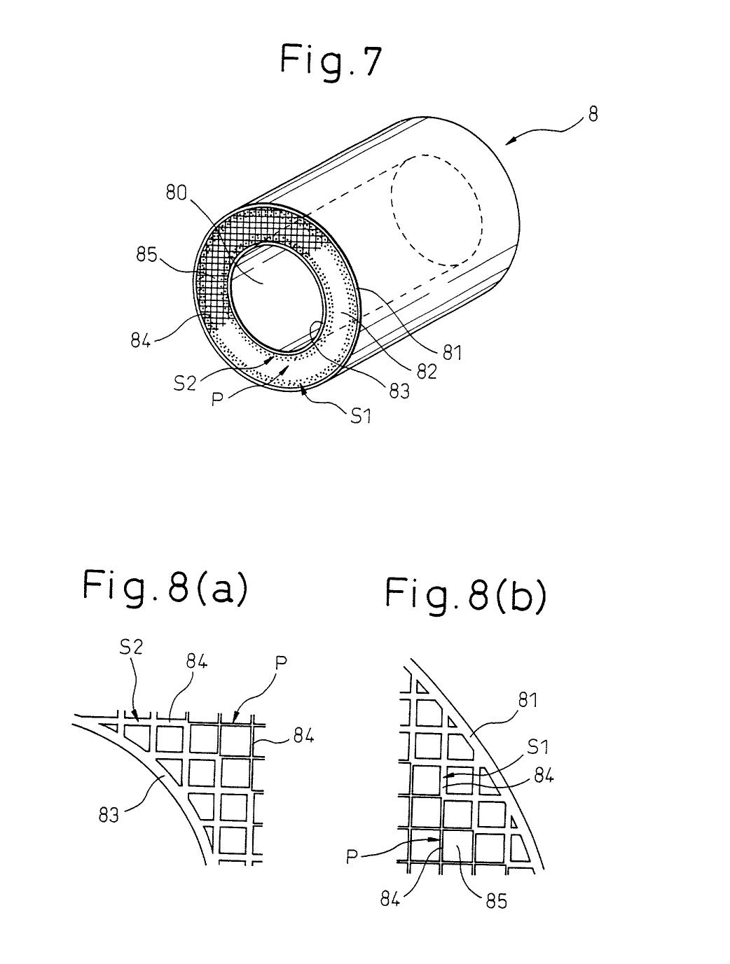

In the hollow ceramic monolithic support 8 manufactured in this example, as shown in FIGS. 7, 8(a) and 8(b), the ribs 84 located near the inner periphery skin portion 83 and the outer periphery skin portion 81 have higher strength than other ribs, in contrast to the hollow ceramic monolithic support 8 manufactured in the first embodiment.

In the hollow ceramic monolithic support 8 described above, the ribs 84 located in a layer about one cell (one or more cells) from the inner periphery skin portion 83 are made with a high-strength portion S2 having higher strength than an ordinary portion P consisting of the ribs located outside thereof. Also the ribs 84 located in a layer about one cell from the outer periphery skin portion 81 are made in a high strength portion S1 having higher strength than the ordinary portion P consisting of the ribs located inside thereof.

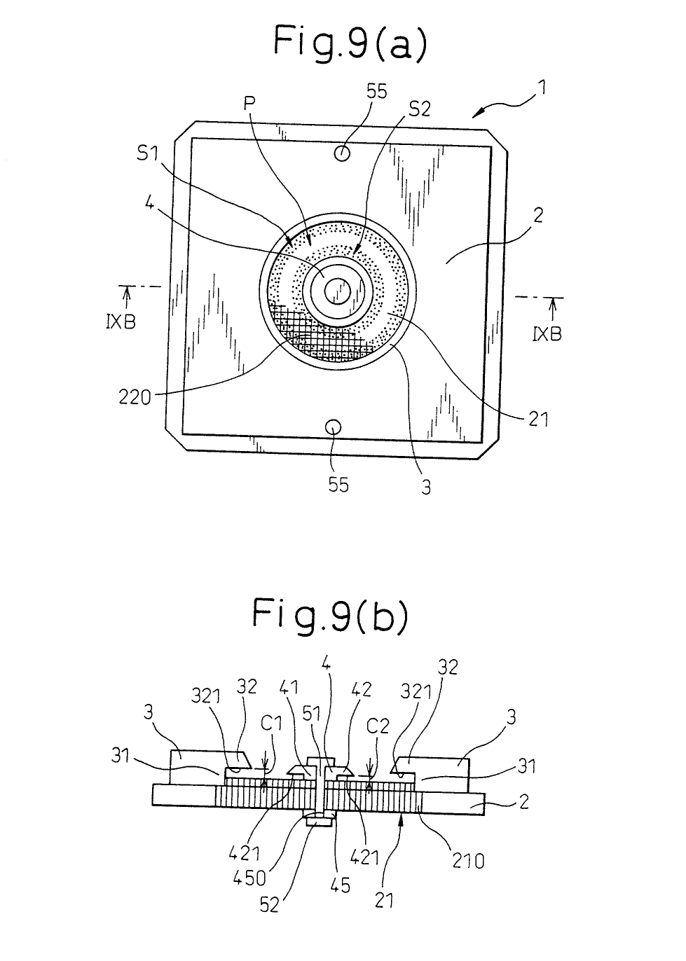

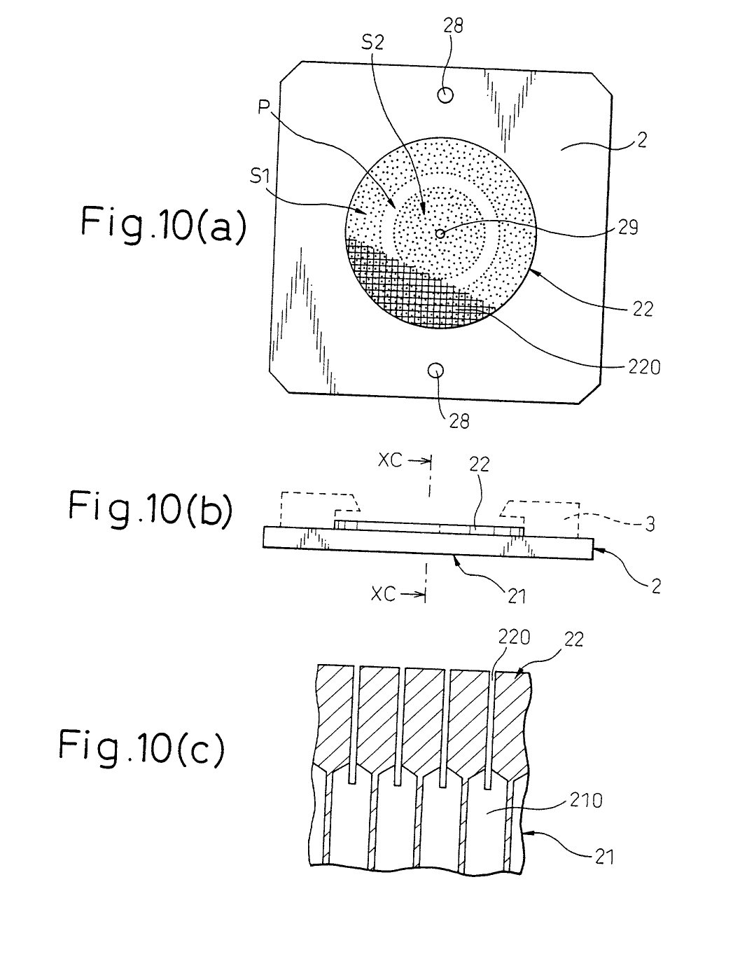

The molding die 1 used in this example is a variation of the molding die 1 of the first embodiment wherein the die 2 is modified as shown in FIGS. 9(a) to 10(c). In the die 2, width of the slit 220 located in the region S1 near the periphery of the slit section 22 and in the central region S2 is made larger than the width of the slits 220 located in the ordinary region P located between S1 and S2. Specifically, width of the slits 220 located in the region P is set to 80 μm, and width of the slits 220 located in the regions S1 and S2 is set to 107 μm.

When the molding die 1 having the constitution described above is used, the high strength regions S1 and S2 of the ribs 84 can be made stronger by making the thickness thereof larger than that in the ordinary portion P. Specifically, thickness of the ribs 84 was about 100 μm in the high strength regions S1 and S2 and about 75 μm in the ordinary region P.

Thickness of the ribs 84 can be set within a range from about 50 to about 150 μm depending on the application. When the high strength regions S1 and S2 are formed with thick ribs, it is desired to make the thickness 1.1 to 3 times that of the ordinary portion P. When the thickness ratio is below 1.1, the strength cannot be increased sufficiently and, when the thickness ratio is larger than 3, the pressure loss becomes too large.

The high strength regions S1 and S2 of the hollow ceramic monolithic support 8 can be extended to up to 10 cells.

This embodiment is similar to the first embodiment in other aspects of constitution, operation and effect.

Third Embodiment

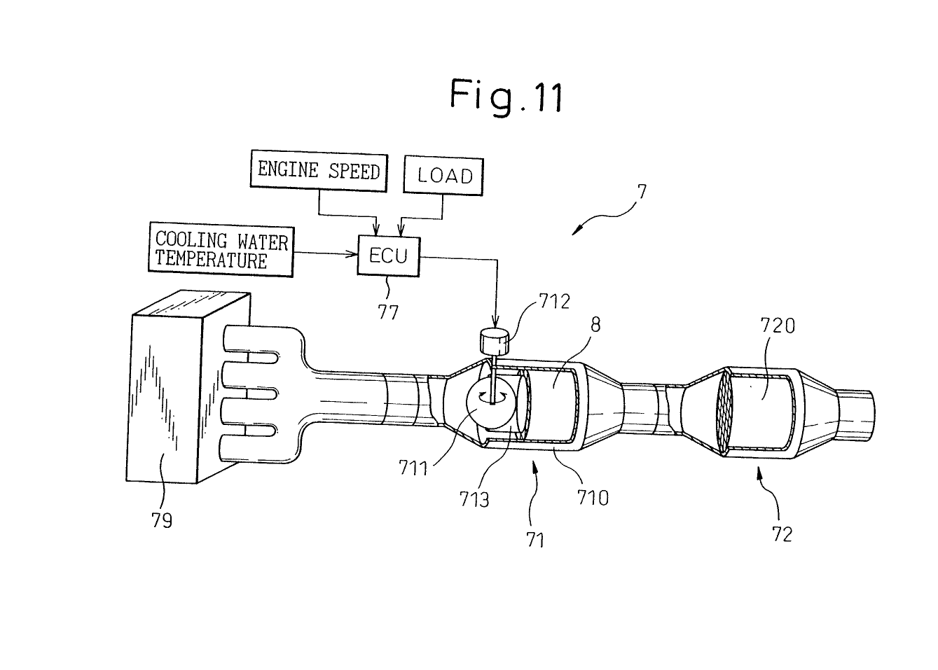

This embodiment is an example of applying the hollow ceramic monolithic support 8 of the second embodiment to a catalytic converter system as shown in FIG. 11.

The catalytic converter system 7 of this example is an exhaust gas purifying system for automobile having two catalytic converters 71, 72 installed in series as shown in the drawing. The catalytic converter 71 is a CC catalyst and the catalytic converter 72 is an UF catalyst.

The CC catalyst 71 is constituted by installing the hollow ceramic monolithic support 8, a butterfly valve 711, an actuator 712 and a bypass passageway 713 in a casing 710. The actuator 712 may be driven either by an electromagnetic motor or by negative pressure. In this example, the hollow ceramic monolithic support 8 carries a very low temperature activating catalyst, of which the activation initiating temperature is 300° C., supported thereon. Specifically, Pd (palladium) having a mean particle size of 1 nm or less is supported.

The UF catalyst 72 uses a conventional monolithic support 720 of cylindrical shape, with Pt (platinum) and Rh (rhodium) supported on the monolithic support 720. The catalyst can be supported by various methods that have been reported and any of which can be applied to this case, it is preferable to fire active alumina and the noble metal together.

The CC catalyst 71 is made by inserting the hollow ceramic monolithic support 8 wrapped by a mat made of alumina fibers into a converter casing 710 under pressure. The hollow ceramic monolithic support 8 must have isostatic strength to endure the pressure of insertion, specifically 1 MPa or higher pressure. It has been difficult to ensure this strength in the case of the conventional hollow ceramic monolithic support. In the case of the hollow ceramic monolithic support 8 described above, an isostatic strength of 1 MPa or higher can be easily ensured as the high strength regions S1 and S2 having thick ribs are provided along with the outer periphery skin portion 81 and the inner periphery skin portion 83 as shown in FIGS. 7, 8(a) and 8(b). Therefore, the hollow ceramic monolithic support 8 will not be destroyed when inserted into the converter casing 710 under pressure.

While the hollow ceramic monolithic support 8 is provided with a tubular member installed as the bypass passageway 713 in the hollow space 80 thereof, a mat made of alumina fibers is installed also in the gap between the hollow ceramic monolithic support 8 and the bypass passageway 713 for the purpose of sealing against exhaust gas and prevention of vibration.

Specifically, while the bypass passageway 713 wrapped by the mat is inserted into the hollow space 80 of the hollow ceramic monolithic support 8 by applying pressure, breakage from the inside can also be prevented at this time. This is because the high strength regions S1 and S2 having the thick ribs are provided along with provision of the outer periphery skin portion 81 and the inner periphery skin portion 83.

Now the operation of the catalytic converter system 7 will be described with reference to FIG. 11. When the internal combustion engine 79 is started in a cold state, namely when a signal from a cooling water temperature sensor, that is not shown in the drawing, indicates a temperature lower than a certain level, the ECU 77 directs the actuator 712 to close the butterfly valve 711. Accordingly, all the exhaust gas discharged from the internal combustion engine 79 passes through the main body 82 of the hollow ceramic monolithic support 8.

As the very low temperature activating catalyst is supported on the ribs 84 of the hollow ceramic monolithic support 8 as described above, a better low temperature activity, than in the conventional CC catalyst, is provided, so as to purify the exhaust gas efficiently when the temperature is low.

Then as the temperature rises, the UF catalyst 72 becomes activated. During the operation of the internal combustion engine, while the butterfly valve 711 remains closed until the load increases to a medium level, the ECU 77 directs the actuator 712 to open the butterfly valve 711 when the load increases to a high level, specifically when the ECC 77 determines that the exhaust gas temperature has reached 80° C. or higher. This causes the exhaust gas to flow into the bypass passageway 713, so that coagulation of the very low temperature activating catalyst due to the heat can be suppressed resulting in higher durability.

At this time, the UF catalyst 72 has already been activated by the heat received from the exhaust gas that has been purified while passing through the CC catalyst. Therefore, toxic component of the exhaust gas, of which the path has been switched by the butterfly valve 711, is purified by the UF catalyst 72 and hardly pollutes the atmosphere. When the load decreases below the medium level, the ECU 77 controls the actuator 712 again to operate the butterfly valve 711 so as to pass the exhaust gas through the main body 82 of the hollow ceramic monolithic support 8.

In this system, as described above, low-temperature activity and heat resistance can be improved and, moreover, the pressure loss can be decreased by the combined use of the hollow ceramic monolithic support 8 and the bypass passageway 713.

Fourth Embodiment

This embodiment is an example of controlling the catalytic converter system 7 of the third embodiment in accordance to the load on the internal combustion engine.

The control process in this example comprises steps S110 (hereinafter referred to simple as S110) through S130 as shown in the control flow chart of FIG. 16.

S110 is a step for determining whether the load on the internal combustion engine is W or higher.

S121 is a step of opening the butterfly valve 711 of the CC catalyst 71 so that the exhaust gas flows through the bypass passageway 713 of the hollow ceramic monolithic support 8.

S122 is a step of closing the butterfly valve 711 so that the exhaust gas flows through the main body 82 of the hollow ceramic monolithic support 8.

In this example, the load on the internal combustion engine was estimated by using the degree of throttle opening and the amount of air intake of the internal combustion engine. A preparatory experiment was conducted before implementing this example. It was found in the experiment that there may be a case that the very low temperature activating catalyst coagulates due to heat when the operation of the internal combustion engine exceeds a medium load. Accordingly, the value W was set equal to medium load for the threshold in S110.

The catalytic converter system 7 was controlled according to the control flow chart organized as described above.

In this control process, when the load on the internal combustion engine is below W, the butterfly valve 711 is closed. This causes all the exhaust gas of which the temperature is relatively low to pass through the main body 82 of the hollow ceramic monolithic support 8. When the load on the internal combustion engine is higher than W, on the other hand, the butterfly valve 711 is opened. This causes all the exhaust gas of high temperature to pass through the bypass passageway 713. As a result, according to this example, an exhaust gas of a wide temperature range, from a low to a high temperature, can be efficiently purified similarly to the third embodiment.

Particularly, in this example, the load on the internal combustion engine is estimated according to the degree of throttle opening and the amount of air intake of the internal combustion engine. As a result, stable control can be carried out while simplifying the constitution of the catalytic converter system 7.

The load on the internal combustion engine can also be estimated by using such parameters as the vehicle speed or acceleration besides the degree of throttle opening and the amount of air intake described above.

This embodiment is similar to the third embodiment in other aspects of constitution, operation and effect.

Fifth Embodiment

This embodiment is an example of controlling the catalytic converter system 7 of the third embodiment in accordance to the cooling water temperature of the internal combustion engine.

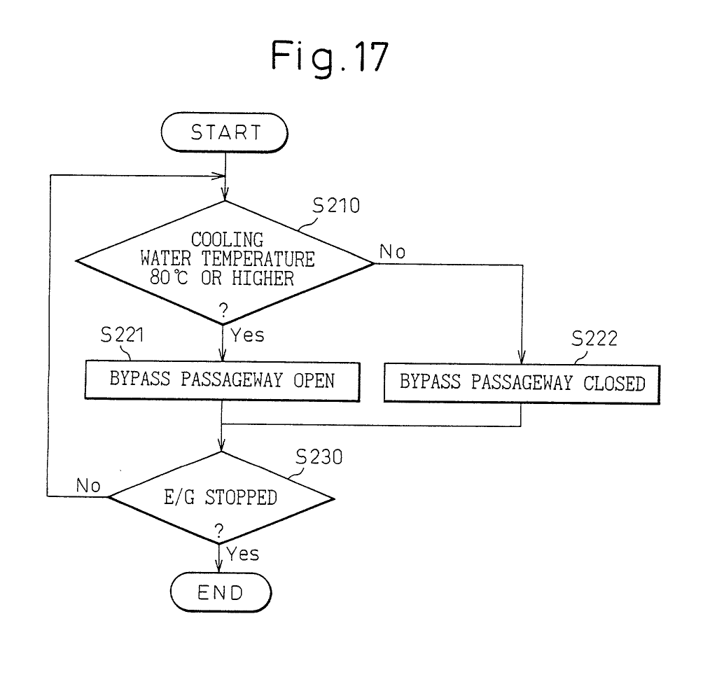

Control process in this example comprises steps S210 through S230 as shown in the control flow chart of FIG. 17.

S210 is a step of determining whether the cooling water temperature is 80° C. or higher or not.

S221 is a step of opening the butterfly valve 711 of the CC catalyst 71 so that the exhaust gas flows through the bypass passageway 713 of the hollow ceramic monolithic support 8.

S222 is a step of closing the butterfly valve 711 so that the exhaust gas flows through the main body 82 of the hollow ceramic monolithic support 8.

The catalytic converter system 7 was controlled according to the control flow chart organized as described above.

In this control process, when the cooling water temperature is below 80° C., the butterfly valve 711 is closed. This causes all the exhaust gas of which temperature is relatively low to pass through the main body 82 of the hollow ceramic monolithic support 8. When the cooling water temperature reaches 80° C. or higher, on the other hand, the butterfly valve 711 is opened. This causes the exhaust gas at high temperature to pass through the bypass passageway 713. As a result, according to this example, an exhaust gas of a wide temperature range, from a low to a high temperature, can be efficiently purified similarly to the third embodiment.

Particularly, in this example, the catalytic converter system 7 is controlled in accordance to the cooling water temperature. As a result, stable control can be carried out while simplifying the constitution and at low cost.

This embodiment is similar to the third embodiment in other aspects of constitution, operation and effect.

Six Embodiment

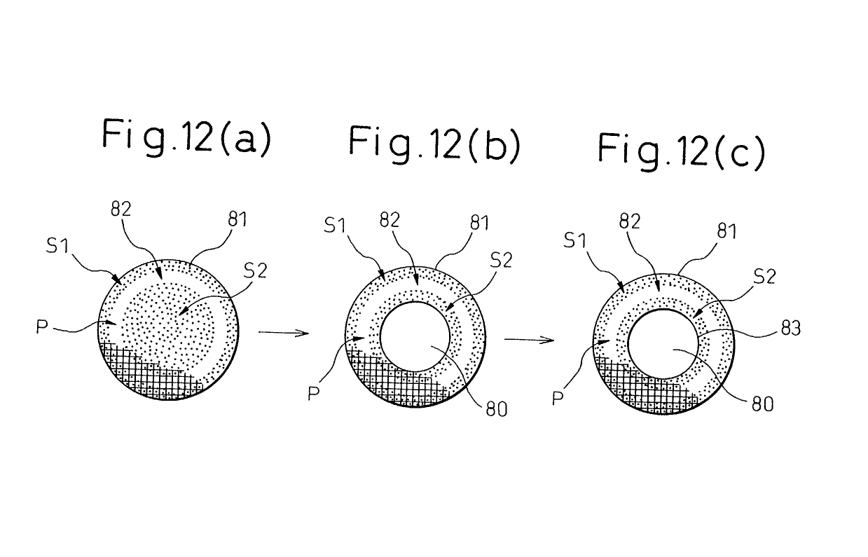

This embodiment is an example of manufacturing the hollow ceramic monolithic support 8 of the same shape as that of the second embodiment by another manufacturing method, as shown in FIGS. 12(a) through 12(c).

Specifically, in this example, a ceramic monolithic support is manufactured as an intermediate product by using a molding die that is made by assembling only the outer periphery guide ring 3 on the die 2 without providing the inner periphery guide ring 4, instead of the molding die 1 of the second embodiment. Accordingly, the ceramic monolithic support does not have a hollow space in the main body 82 thereof, but has the outer periphery skin portion 81 instead, as shown in FIG. 12(a). The ribs 84 in the central portion and in the peripheral portion of the main body 82 are made thicker to form the high strength regions S1, S2. There is the ordinary portion P between the high strength regions S1 and S2.

Then the hollow space 80 is made in a boring process in which only the peripheral portion of the high strength region S1 at the center remains, as shown in FIG. 12(b).

Then as shown in FIG. 12(c), the inner periphery skin portion 83 is formed by attaching the ceramic material, that makes cordierite, to the inner peripheral surface of the main body 82.

Then the final product is obtained through processes such as drying and firing.

In this example, unlike the second embodiment, the hollow ceramic monolithic support 8 that has the high strength regions S1 and S2 along with the outer periphery skin portion 81 and the inner periphery skin portion 83 as shown in FIG. 12(c) can be manufactured if a boring process is employed, rather than molding the hollow ceramic monolithic support in a single run in the extrusion molding process.

An operation and an effect, similar to those of the first embodiment, can be achieved in this case.

What is claimed is:

1. A molding die for a hollow ceramic monolithic support comprising:
a die that has an introduction hole section provided with introduction holes through which a material is introduced, and a slit section provided with slits that communicate with said introduction holes for molding the material into honeycomb shape;
an outer periphery guide ring having an outer periphery erected portion that extends from the outer peripheral end of said slit section in the extruding direction, and an outer periphery protruding portion that protrudes from said outer periphery erected portion inward and is separated from said slit section by a gap provided therebetween; and
an inner periphery guide ring having an inner periphery erected portion that extends from the central portion of said slit section in the extruding direction, and an inner periphery protruding portion that protrudes from said inner periphery erected portion outward and is separated from said slit section by a gap provided therebetween.

2. The molding die for a hollow ceramic monolithic support according to claim 1, wherein the gap between said inner periphery protruding portion and said slit section is in a range from 0.05 to 2 mm.

3. The molding die for a hollow ceramic monolithic support according to claim 1, wherein the ratio C1/C2 is in a range from 0.8 to 1.2 with C1 being the gap between said outer periphery protruding portion and said slit section and C2 being the gap between said inner periphery protruding portion and said slit section.

4. The molding die for a hollow ceramic monolithic support according to claim 1, wherein the slits located in a layer of a size one to 10 cells from the distal end of said inner periphery protruding portion outward have a width larger than that of the other slits in said die.

5. The molding die for a hollow ceramic monolithic support according to claim 1, wherein the slits located in a layer of one to 10 cells from the distal end of said outer periphery protruding portion inward have width larger than that of the other slits in said die.

6. A method of manufacturing a hollow ceramic monolithic support, which comprises manufacturing a hollow ceramic monolithic support that has a hollow space in an inner periphery skin portion thereof, by extrusion molding a ceramic material using a molding die comprising a die that has an introduction hole section provided with introduction holes through which the material is introduced and a slit section having slits that communicate with the introduction holes for forming the material into honeycomb shape, an outer periphery guide ring that has an outer periphery erected portion extending from the outer peripheral end of said slit section along the extruding direction and an outer periphery protruding portion protruding from said outer periphery erected portion inward while being separated from the slit by a gap provided therebetween, and an inner periphery guide ring that has an inner periphery erected portion extending from the center of said slit section along the extruding direction and an inner periphery protruding portion protruding from said inner periphery erected portion outward while being separated from said slit section by a gap provided therebetween;
wherein the outer periphery skin portion is formed from the ceramic material that passes through the gap between said outer periphery protruding portion and said slit section of said outer periphery guide ring, the inner periphery skin portion is formed from the ceramic material that passes through the gap between said inner periphery protruding portion and said slit section of said inner periphery guide ring, and the main body of the honeycomb structure surrounded by said inner periphery skin portion and said outer periphery skin portion is formed from the ceramic material that is extruded through said slit section, thereby to make the hollow ceramic monolithic support that has the hollow portion in the inner periphery skin portion.

7. The method of manufacturing the hollow ceramic monolithic support according to claim 6, wherein the gap between said inner periphery protruding portion and said slit section is in a range from 0.05 to 2 mm.

8. The method of manufacturing the hollow ceramic monolithic support according to claim 6, wherein the ratio C1/C2 is in a range from 0.8 to 1.2 with C1 being the gap between said outer periphery protruding portion and said slit section and C2 being the gap between said inner periphery protruding portion and said slit section.

9. The method of manufacturing the hollow ceramic monolithic support according to claim 6, wherein said slits located in a layer of from one to 10 cells from the distal end of said inner periphery protruding portion outward have width larger than that of the other slits in said die.

10. The method of manufacturing the hollow ceramic monolithic support according to claim 6, wherein the slits located in a layer in a range from one to 10 cells from the distal end of said outer periphery protruding portion inward have width larger than that of the other slits in said die.

11. A hollow ceramic monolithic support comprising:
a main body that has a multitude of cells surrounded by ribs of honeycomb structure;
a hollow space formed to penetrate said main body at the central portion thereof in the longitudinal direction;
an outer periphery skin portion that covers the outer peripheral surface of said main body; and
an inner periphery skin portion that covers the inner peripheral surface of said main body,
wherein said ribs located in a layer in a range from one to 10 cells from said inner periphery skin portion are made to form a high strength portion that has higher strength than the other portion of ribs located outside thereof.

12. The hollow ceramic monolithic support according to claim 11, wherein said ribs located in a layer in a range from one to 10 cells from said outer periphery skin portion are made to form a high strength portion that has higher strength than the other portion of ribs located inward.

13. The hollow ceramic monolithic support according to claim 11, wherein said ribs of the high strength portion are made thicker than the ribs in the other portion thereby increasing the strength.

14. The hollow ceramic monolithic support according to claim 11, wherein the ratio T1/T2 is in a range from 0.8 to 1.2 with T1 being the thickness of said outer periphery skin portion and T2 being the thickness of said inner periphery skin portion.

15. A catalytic converter system to be installed in the exhaust system of an internal combustion engine comprising:
a first catalytic converter constituted from the hollow ceramic monolithic support of claim 11 and a second catalytic converter constituted from a solid ceramic monolithic support that has a multitude of cells surrounded by ribs in honeycomb structure and an outer periphery skin portion that covers the outer peripheral surface thereof,
wherein said first catalytic converter is disposed upstream in the exhaust system, incorporates the hollow ceramic monolithic support that has a first catalyst supported thereon and has a bypass passageway disposed in the hollow space, a purifying path consisting of the multitude of cells disposed to surround the bypass passageway and passageway switching means that switches the passageway for the exhaust gas between the bypass passageway and the purifying path, and
the second catalytic converter incorporates the solid ceramic monolithic support disposed downstream of said exhaust system and having a second catalyst supported thereon,
while said first catalyst begins to be activated at a lower temperature than the second catalyst does.

16. The catalytic converter system according to claim 15, wherein said passageway switching means is constituted so as to switch between said bypass passageway and said purifying path according to the load on said internal combustion engine.

17. The catalytic converter system according to claim 15, wherein said passageway switching means is constituted so as to switch between said bypass passageway and said purifying path according to the cooling medium temperature of said internal combustion engine.

18. The catalytic converter system according to claim 15, wherein said passageway switching means is constituted so as to switch between said bypass passageway and said purifying path according to a combination of the load on said internal combustion engine and the temperature of said cooling medium.

19. The catalytic converter system according to claim 15, wherein said first catalyst is a very low temperature activating catalyst of which activation initiating temperature is 300° C. or lower.

20. The catalytic converter system according to claim 15, wherein said first catalyst is a very low temperature activating catalyst of which activation initiating temperature is 200° C. or lower.
